(19) United States
(12) Patent Application Publication
(10) Pub. No.: US 2024/0427567 A1
(43) Pub. Date: Dec. 26, 2024

(54) DEVELOPMENT ENVIRONMENT INTEGRATED WITH A LARGE LANGUAGE MODEL

(71) Applicant: Couchbase, Inc., Santa Clara, CA (US)

(72) Inventors: Raghupathi Keshava Murthy, Union City, CA (US); Gopinath Duddi, Palo Alto, CA (US); Robert L. Ashcom, JR., San Jose, CA (US); Terrence Lee, San Jose, CA (US)

(21) Appl. No.: 18/751,041

(22) Filed: Jun. 21, 2024

Related U.S. Application Data
(60) Provisional application No. 63/523,009, filed on Jun. 23, 2023.

(51) Int. Cl. G06F 8/33; G06F 8/10; G06F 16/21

(52) U.S. Cl. CPC G06F 8/33; G06F 8/10; G06F 16/211

(57) ABSTRACT

A system allows generation of information used by an integrated development environment using a machine learning-based language model, for example, a large language model. The integrated development environment is for developing applications, e.g., database applications. The system receives a natural language request for information related to development of the database application. The system determines contextual information describing a development task associated with the database application and generates a prompt for a machine learning based language model based on the natural language request and the contextual information and receives a response. The system extracts the information related to development of the database application from the response. In response to a natural request, the system may generate a database query, provide a resultset by executing the database query, automatically determine a type of chart and generate one or more charts for visually displaying the result.

### CROSS REFERENCE TO RELATED APPLICATIONS

This application claims the benefit of U.S. Provisional Application No. 63/523,009, filed Jun. 23, 2023, which is hereby incorporated in its entirety by reference.

### BACKGROUND

### Field of Art

This disclosure relates in general to machine learning, and in particular to integrating machine learning based language models with a development environment for enhancing various aspects of application development including developing and modifying the database schema, sample datasets, database queries, application code, and so on.

### Description of the Related Art

Integrated development environments (IDEs) are used for developing applications, for example, database applications. The applications may be written using a programming language such as JAVA, PYTHON, or any other programming language. The application typically stores data in a database and accesses it using the application programming interfaces (APIs) of the database. Such development environments facilitate the software development process to a large extent by allowing users (e.g., developers) to write code as well as debug and test code. However, the developer needs to provide all the input needed to perform any step of the development process. The input may be provided in the form of text or via graphical user interface. For example, the developer provides sample data for testing and debugging, interacts with the database for storing the data, writes test cases, and so on. As a result, development of such applications is typically a cumbersome process.

### SUMMARY

A system allows generation of information used by an integrated development environment using a machine learning-based language model, for example, a large language model (LLM). The system configures a user interface of the integrated development environment for developing applications, for example, database applications. The user interface is configured to display one or more of: code being developed for a database application, a schema of a database for storing data of the database application, or sample data processed by the database application. The system sends the user interface of the integrated development environment for display via a client device.

The system receives via the user interface of the integrated development environment, a natural language request for information related to development of the database application. The system determines contextual information describing a development task associated with the database application being developed. The system generates a prompt for input to a machine learning based language model based on the natural language request and the contextual information. The system provides the prompt to the machine learning based language model for execution and receives a response from the machine learning based language model. The system extracts the information related to development of the database application from the response and may display the information via the user interface of the integrated development environment.

According to an embodiment, the information related to development of the database application represents sample data for providing as input to the code being developed for the database application. According to an embodiment, the information related to development of the database application represents unit tests for testing the database application.

According to an embodiment, the information related to development of the database application represents description of a schema for storing data processed by the database application. The information related to development of the database application may represent database commands for generating the schema of a database for storing data processed by the database application. The information related to development of the database application may represent one or more database queries for accessing data stored using the schema of the database. The information related to development of the database application may represent information describing one or more indexes for efficient execution of the one or more database queries for accessing data stored using the schema of the database. The information related to development of the database application may represent database commands for generating one or more indexes for efficient execution of the one or more database queries for accessing data stored using the schema of the database and the system further executes the database commands.

Embodiments of the invention include computer-implemented methods described herein, a non-transitory computer readable storage medium storing instructions for performing steps of the methods disclosed herein, and systems comprising processors and computer readable non-transitory storage medium to perform steps of the methods disclosed herein.

### BRIEF DESCRIPTION OF DRAWINGS

FIG. 1 is a block diagram of a document-oriented database system environment for performing optimized database queries, according to one embodiment.

FIG. 2 is a block diagram illustrating the architecture and data flow of the query module for performing optimized JSON database queries, according to one embodiment.

FIG. 3 is a flow chart showing a process illustrating a workflow using the integrated development environment, according to an embodiment.

FIG. 4 is a flow chart illustrating the process of generating using the LLM, sample data for testing an application being developed, according to an embodiment.

FIG. 5 is a flow chart illustrating the process of generating database queries based on LLMs, according to an embodiment.

FIG. 6 is a flow chart illustrating the process of generating unit tests using LLMs, according to an embodiment.

FIG. 7 shows a user interface of the integrated development environment, according to an embodiment.

FIG. 8A shows an example user interface of the integrated development environment receiving a user request to generate data, according to an embodiment.

FIG. 8B shows an example user interface of the integrated development environment displaying the generates data, according to an embodiment.

FIG. 8C shows an example user interface of the integrated development environment receiving a user request to modify the generated data, according to an embodiment.

FIG. 8D shows an example user interface of the integrated development environment displaying the generates data, according to an embodiment.

FIG. 8E shows an example user interface of the integrated development environment receiving a user request to generate a query to access the generated data, according to an embodiment.

FIG. 8F shows an example user interface of the integrated development environment displaying the generated data, according to an embodiment.

FIG. 8G shows an example user interface of the integrated development environment displaying an index generated by the system, according to an embodiment.

FIG. 8H shows an example user interface of the integrated development environment displaying an execution plan, according to an embodiment.

FIG. 8I shows an example user interface of the integrated development environment receiving a user request to generate code to access the generated data, according to an embodiment.

FIG. 8J shows an example user interface of the integrated development environment displaying the code for accessing the generated data, according to an embodiment.

FIG. 8K shows an example user interface of the integrated development environment displaying information generated, according to an embodiment.

FIG. 9 is a high-level block diagram illustrating a functional view of a typical computer system for use as one of the entities illustrated in the system environment 100 of FIG. 1 according to an embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “115a,” indicates that the text refers specifically to the element having that particular reference numeral. A reference numeral in the text without a following letter, such as “115,” refers to any or all of the elements in the figures bearing that reference numeral.

### DETAILED DESCRIPTION

Various tools such as chatbots use large language models (LLMs) for generating responses to natural language questions or for generating various types of information. An LLM may be trained for a specific user or a set of users such as a tenant of a multi-tenant system, or for a context, or user case. As a result, the LLM is fine-tuned for that specific tenant, context, or use case. The fine-tuned LLM acts like an expert for a given field. Since a user may not be an expert in the field, the user may not know the right questions to ask to an LLM or the right way to phrase a question so that the LLM can provide the necessary information.

A system according to various embodiments comprises a development environment (also referred to herein as an integrated development environment or IDE) that allows developers to develop code for applications such as database applications. The development environment interacts with a large language model (LLM), for example, GPT (generative pretrained transformed) model to help developers with various stages of development, deployment, and refinement. These include generating sample data for use in development and testing of software, generating database queries for processing the generated data, generating unit tests, translating from a high level (business) requirement to a specification that is domain specific, and so on. The system receives a prompt from the user specifying the type of help that the user needs using natural language. The system may also suggest the next step/prompt to the user depending on the context. A large language model may return irrelevant information or inaccurate information if the prompt specified by the user is ambiguous or vague. Therefore, the system modifies the prompt, i.e., the system rewrites the prompt by adding additional information describing the context or schema to the prompt. The system executes the LLM using the rewritten prompt to obtain information that is provided to the user, for example via a user interface of the development environment.

### System Environment

Following is the overall system environment of the system according to an embodiment. Although the techniques disclosed are described in the context of a document-oriented database, the techniques are applicable to other types of databases, for example, relational databases, graph databases, search systems, NoSQL databases, spatial databases, and so on.

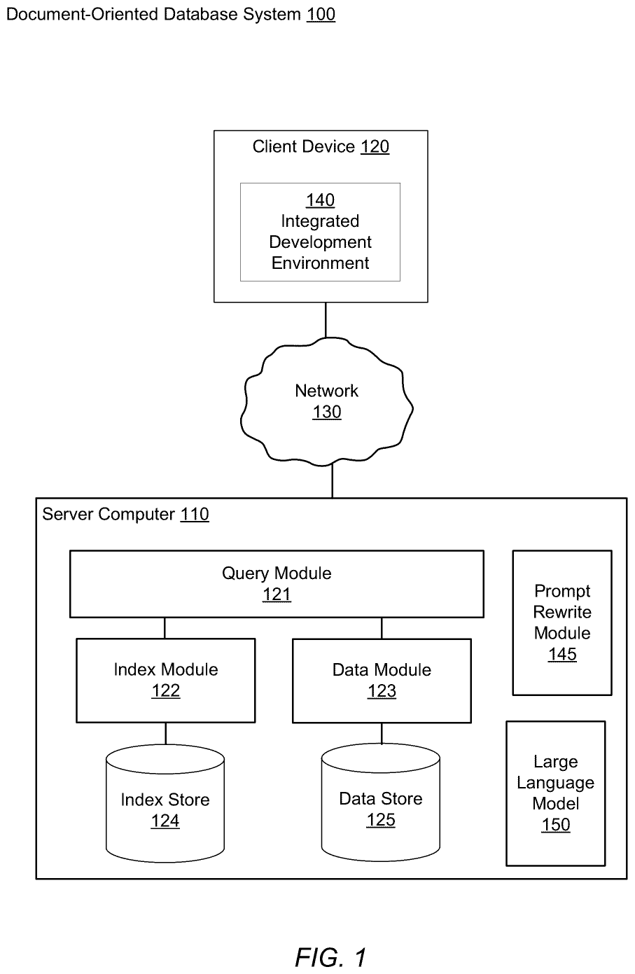

FIG. 1 is a block diagram of a system environment 100 for performing optimized database queries, according to one embodiment. The system environment includes a server computer 110, a client device 120, and a network 130. Other embodiments may use more or fewer or different systems than those illustrated in FIG. 1. Functions of various modules and systems described herein can be implemented by other modules and/or systems than those described herein.

The server computer 110 receives and processes document-oriented database queries. The server computer 110 includes a query module 121, index module 122, data module 123, index store 124, a data store 125, a prompt rewrite module 145, and a large language model 150. Although FIG. 1 shows a single element, the server computer 110 broadly represents one or multiple server computers, such as a server computer, and the server computer may be located in one or more physical locations. Different components of the server computer 110 may execute on different processors. For example, the large language model 150 may execute on a different computing system that the server computer 110. The various components may interact with the large language model 150 via APIs provided by the large language model 150. The server computer 110 also may represent one or more virtual computing instances that execute using one or more computers in a datacenter such as a virtual server farm.

The large language model 150 may be machine learning based model that is trained to perform natural language processing tasks such as text generation, language translation, and so on. According to an embodiment, the large language model 150 is a neural network, for example, a generative pretrained transformer model, a generative-adversarial networks (GAN), a diffusion model, and the like. According to an embodiment, the large language model 150 is trained on a large corpus of training data for example, websites, articles, posts on the web, books, and the like. The large language model 150 may have a significant number of parameters, for example, 1 billion, 15 billion, or 175 billion parameters or more. The large language model 150 may be provided by a service by an external system such that the server computer 110 interacts with the external system using APIs (application programming interfaces) supported by the external system. For example, the server computer 110 may generate a prompt and send the prompt to the large language model 150 executing on the external system by invoking an API that returns the response of the large language model 150. The API may be invoked by sending data over a network, for example, the internet.

The server computer 110 configures a user interface of an integrated development environment 140 and sends the user interface for display via the client device 120. The integrated development environment 140 allows users to develop an application, for example, a database application. The database application may be developed using a programming language such as Java, C, C++, Python and so on. The database application may process data stored in a database using a database query language such as the structured query language (SQL).

The client device 120 sends database queries for data stored at server computer 110. In particular, a client application running on client device 120 sends requests to retrieve or update data (e.g., database queries) to the server computer 110 over the network 130. The client application then receives data in response to the request from the server computer 110 sent back over the network 130. The data received in response may indicate to the client application that the request was successfully executed and may additionally include data queried in the request. An example of a client application is an integrated development environment 140.

The integrated development environment 140 includes a user interface that allows a user, for example a developer, to interact with the server computer for development of code, for example, code for a database application. The integrated development environment 140 allows developers to input natural language requests for generating sample data, unit tests, database queries, sample code modules, and so on. The server computer 110 interacts with the large language model 150 for generating responses to natural language questions of the user.

According to an embodiment, the server computer 110 receives the prompt provided by the user via the integrated development environment 140, the prompt representing a natural language request for generating information used for development of the application. The prompt rewrite module 145 performs prompt rewrites to generate a prompt equivalent to a user provided prompt that is more optimal for the LLM. The rewritten prompt when provided to the LLM returns more relevant information needed in the development context compared to the user provided prompt. The LLMs are trained on a large corpus of documents that may include expert written papers, textbooks, and so on. The system may rewrite the prompt provided by the user to use domain specific language/words.

According to an embodiment, the system may identify the type of database for which an application is being developed and rewrite the prompt to achieve optimal results for specific type of the database. For example, the type of prompt generated to obtain the same information from the LLM may be different if the underlying database is a document-oriented database vs. a relational database. The system may perform a prompt rewrite that depends on the vendor of the database since different vendors support different types of database features. Accordingly, the system generates prompt suitable for the context in which the application is being developed and uses the rewritten prompt to retrieve information from the LLM. The information retrieved from the LLM is used to help the user with the development process as well as by the development environment to determine actions to be taken.

The term database query, as used herein, refers to a request to access or manipulate data stored by one or more fields in a collection of documents in a document-oriented database. Fields are discussed in greater detail below with reference to the index module 122. In response to receiving a database query the server computer 110 retrieves the data requested in the query (e.g., stored in data store 125) and transmits the data over the network 130. The server computer 110 may be any computing device, including but not limited to: servers, racks, workstations, personal computers, general purpose computers, laptops, Internet appliances, wireless devices, wired devices, multi-processor systems, mini-computers, and the like.

According to some embodiments, the server computer 110 generates sample database queries using the large language model 150 for testing an application being developed. The server computer 110 may generate sample data for testing an application being developed using the large language model 150. The sample data may be represented using JSON (JavaScript Object Notation). The server computer 110 may also generate database commands using the large language model 150 for generating a schema for storing the sample data in a database. The server computer 110 may also generate using the large language model 150 example database queries for testing the code of the application being developed using the schema generated. The server computer 110 may also generate using the large language model 150 sample code for running the example database queries generated by the large language model 150.

The query module 121 receives and parses database queries in order to retrieve the data requested by the query from the data store 125. In particular, the query module 121 generates a query execution plan by parsing a received query. The term query execution plan (QEP), as used herein, refers to an ordered set of steps for accessing data stored in a database (e.g., data store 125). Based on the generated QEP, the query module 121 obtains query indexes from the index module 122 and then fetches the data corresponding to the obtained query indexes from the data module 123. In some embodiments, the query module 121 generates the QEP using a cost-based optimizer. Indexes are described below in relation to the index module 122.

The index module 122 generates indexes for data stored in the data store 125 and retrieves keys corresponding to data relevant to a received QEP included in the indexes stored in the index store 124. In particular, the index module 122 may generate indexes for one or more untyped fields storing data in the data store 125. The term field, as used herein, refers to an identifier of a group of data value that may be included in a collection of documents stored in the data store 125, where each document in the collection has one or more data values stored in association with a given field. For example, if the collection is “users,” each user may have a “name” field which stores the relevant user's name, such as “Bailey.” The term “untyped field,” as used herein, refers to a field which can store data of multiple data types across different documents, such as strings, numbers, arrays, objects, etc. (e.g., JSON data types). In general, a field is untyped in a document-oriented database because a corresponding collection of documents stored in the database does not have a predefined schema for the stored documents.

The index module 122 provides the retrieved keys to other components of the server computer 110. Additionally, the index module 122 may store generated indexes in the index store 124. The term key, as used herein, refers to an identifier of one or more individual data values stored by a field in one or more documents in the database (e.g., a number, an object, a number in an array, etc.) and may be represented using an identifier such as a string, a number, a Uniform Resource Identifier (URI), or a path. An index, as used herein, refers to a data structure that improves the speed of data retrieval in response to a query by logically organizing keys associated with one or more fields. An example data structure representation of an index is a B+ Tree. The index module 122 may generate indexes in response to the server computer 110 receiving new data for storage in data store 125 or receiving a request to generate or update an index for one or more keys.

The data module 123 receives a set of keys related to a query and fetches the data stored in data store 125 corresponding to the keys. The data module 123 may fetch documents containing the data requested by a received query stored in the data based on the set of keys. The documents may then be processed (e.g., by query module 121) in order to provide the specific data contained within the documents requested by the query. In other cases, the data module 123 may fetch the exact data requested by the query and provide the data to other components of the server computer 110.

The index store 124 stores indexes generated by the server computer 110 for data entries stored in the data store 125. In one embodiment, the index store 124 is integrated with the data store 125. According to various embodiments, the server computer 110 sends a prompt to the large language model 150 requesting the large language model 150 to generate database commands for creating indexes for efficient execution of database queries that are processed by the application being developed using the integrated development environment 140.

The data store 125 may be a documented oriented database (e.g., a JSON, XML, or YAML database). According to various embodiments, the server computer 110 may use the large language model 150 to generate a schema of the documents stored in the documented oriented database. According to other embodiments, the data store 125 is a relational database that stores data as relational tables. The server computer 110 may use the language model 150 to generate a schema of the relational database for storing data processed by the application being developed using the integrated development environment 140. According to an embodiment, the server computer 110 provides description of the current schema and requests the large language model 150 to generate database commands to modify the schema, for example, to modify the schema to correspond to a new schema for storing data processed by the application being developed. For example, the schema used for storing the sample data being generated may get modified during the development process as new information is received or discovered. For example, code submissions performed by other developers may cause the contextual information provided in a prompt to change the structure of the sample data generated for testing the application. As a result, subsequent requests to describe the schema for storing the updated data may result in the large language model 150 generating a different schema than the one generated previously. If the previous version of schema was created and being used for testing the database application, the server computer 110 sends a request to the large language model 150 to generate database commands to modify the schema used for storing the sample data to conform to the new sample data that was generated by the large language model 150.

According to an embodiment, the data store 125 stores collections of documents (i.e., collections), where each document in the collection includes a set of fields storing data values. For example, the data store 125 may include a collection of users, where each user is represented by a document that includes the fields: name, address, and age. A record, as used herein, is the set of values assigned to the fields of a document. For example, a user record might be: {name: Bailey, address: 123 California St., San Francisco, age: 23}. In one embodiment, the data store 125 is a JSON database. In this case, the data values stored in the data store 125 may be represented by any of the JSON scalar data types which include strings, numbers (e.g., integers, floating point values, etc.), Boolean values, and null values. The term scalar data, as used herein, refers to data consisting of a single value. Additionally, the data stored in the data store 125 may be represented by JSON objects and arrays, each of which may contain one or more scalar data values, arrays, or objects. A document stored by data store 125 may be part of a collection of documents, where each document in the collection includes the same fields.

Example client devices include personal computers (PCs), mobile phones, additional server computers, etc. Other examples of client applications include browser applications and video games. The client device 120 may communicate with the server computer 110 through an Application Programming Interface (API) or a query language. An example API the server computer 110 might provide is a Representation State Transfer (REST) API.

The server computer 110 and client device 120 shown in FIG. 1 can be executed using computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, video game system, etc. The server computer 110 stores the software modules storing instructions for embodiments, for example the query module 121.

The interactions between the client device 120 and the server computer 110 are typically performed via a network 130, for example, via the Internet. In one embodiment, the network uses standard communications technologies and/or protocols. Example networking protocol include the transmission control protocol/Internet protocol (TCP/IP), the user datagram protocol (UDP), internet control message protocol (ICMP), etc. The data exchanged over the network can be represented using technologies and/or formats including JSON, the hypertext markup language (HTML), the extensible markup language (XML), etc. In another embodiment, the entities can use custom and/or dedicated data communications technologies instead of, or in addition to, the ones described above. The techniques disclosed herein can be used with any type of communication technology, so long as the communication technology supports receiving by the server computer 110 of web requests from a sender, for example, a client device 120 and transmitting of results obtained by processing the web request to the sender.

### System Architecture

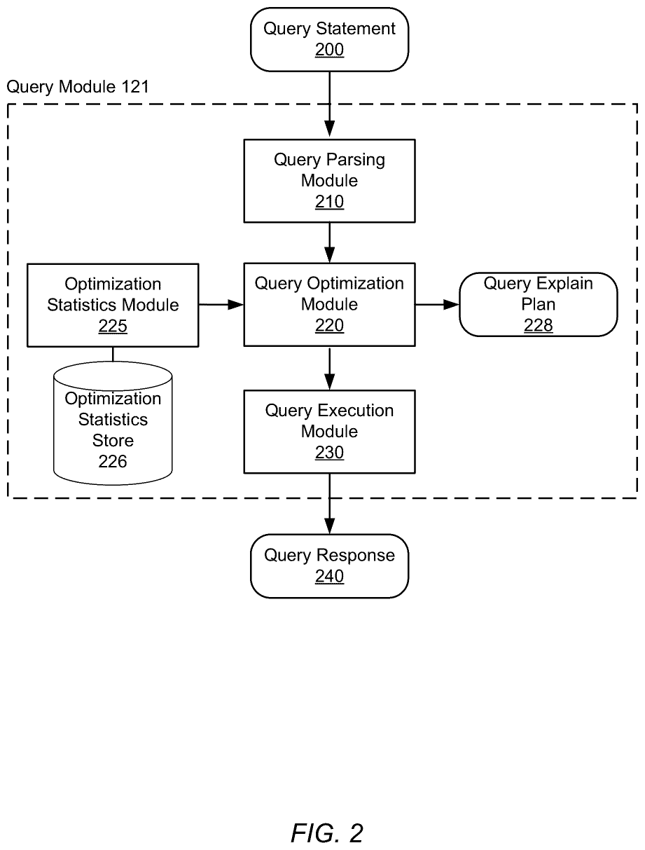

FIG. 2 is a block diagram illustrating the architecture and data flow of the query module 121 for performing optimized JSON database queries, according to one embodiment. Although the query module 121 disclosed performs JSON database queries, other embodiments of the system may perform other types of queries, for example, SQL (structured query language) queries (or any other variation of SQL such as SQL++) processed by a relational database. Although SQL is used as an exemplary database query language, the techniques are not limited to a particular database query language. According to an embodiment, the system generates database queries for a particular context by interacting with an LLM. The query module 121 consists of a query parsing module 210, a query optimization module 220, an optimization statistics module 225, an optimization statistics store 226, a query explain plan 228, and a query execution module 230. Other embodiments can have different and/or other components than the ones described here. Furthermore, the functionalities described herein can be distributed among the components in a different manner.

The query parsing module 210 receives and parses a query statement 200 in order to fetch or update data stored by one or more untyped fields requested by the query. The query parsing module 210 then provides a parsed representation of the query statement 200 to the query optimization module. The query statement 200 is a request to retrieve or manipulate (e.g., update) the data stored by one or more data fields in the documents of one or more collections contained in the data store 125. The query statement 200 may include one or more commands which specify the one or more fields, and additionally may include and one or more filters usable to select certain data values stored by the one or more fields. For example, the query statement 200 may request a set of user objects containing a field (e.g., user birthday) storing a particular value (e.g., February 10^{th}). Example commands which may be included in the query statement are SELECT, JOIN, ORDER, INSERT, UPDATE, DELETE, MERGE, UPSERT, or other data manipulation statements. Example filters with may be included in the query statement are “is equal to,” “is less than,” “is greater than,” “contains,” etc. The query statement 200 may be a set of commands associated with a particular API or query language.

The query optimization module 220 receives a parsed query statement and generates a QEP in order to execute the commands on data in the data store 125 included in the query statement. In particular, the query optimization module 220 determines an optimal QEP from all logically equivalent QEP's for executing the parsed query statement using optimization statistics received from the optimization statistics module 225. For example, two QEPs may include filters on data that are logically equivalent, such as the filters “field value=X” and “field value includes X” The term optimal QEP, as used herein, refers to a QEP which minimizes the cost of execution, where cost is determined based on one or more metrics described in greater detail below. After generating the QEP, the query optimization module 220 provides the QEP to the query execution module 230. In one embodiment, each QEP is represented by an ordered sequence of operators, where each operator describes instructions for a specific operation on the indexes, keys, or data stored in the index store 124 or data store 125. For example, operators may fetch data values stored by a field using keys corresponding to those data values, scan indexes, scan keys included in indexes, join data across multiple documents in a collection, etc. In this case, the query optimization module 220 may determine the cost of individual operators based on the optimization statistics. The optimization statistics may include various statistics corresponding to the indexes, documents, and fields of a collection usable to determine the number of documents accessed by a step in the QEP.

The optimization statistics module 225 generates various statistics describing the data stored in the index store 124 and the data store 125 for use in selecting an optimal QEP. In particular, the optimization statistics module 225 may generate counts, averages, distributions and other statistical values for indexes, fields, and documents included in the collections of documents in data store 125. For example, the optimization statistics module 225 may determine statistics for data collections (i.e., collection statistics) in the optimization statistics data store 226 (e.g., the number of documents in the collection and average document size). As another example, the query execution module 230 may determine statistics for the index corresponding to one or more fields (i.e., index statistics) in the index store 124 (e.g., the number of keys included in the index or the number of unique documents in the collection including data values corresponding to the keys in the index). In one embodiment, the optimization statistics module 225 gathers statistics on the individual fields included in the documents of a collection in the data store 125 describing the distribution of data stored by the fields (i.e., distribution statistics).

The query execution module 230 receives the QEP from the query optimization module 220 and performs the instructions encoded in the QEP. After performing the instructions, the query execution module 230 outputs query results 240, which the server computer 110 further processes (e.g., sends to client device 120). The query execution module 230 may provide instructions to the index module 122 in order to fetch indexes or keys relevant to the data records specified in the QEP. Additionally, the query execution module 230 may provide instructions to the data module 123 for fetching or manipulating the data records specified in the QEP. In some embodiments, the query execution module 230 first retrieves one or more documents including the data specified in the QEP and then performs the operations on the retrieved documents encoded in the QEP. For example, if the QEP is a request for data, the query execution module 230 may filter the documents for the data specified in the QEP, aggregate the filtered data, sort the filtered data, and finally store the filtered data in the query response 240.

The query response 240 represents data generated or retrieved by the query module 121 in response to the query statement 200. For example, if the query statement 200 requests data in the data store 125, the query response 240 will include the requested data. Additionally, the query response 240 may include metadata describing the operations performed by the query module 121 in executing the query statement 200. For example, if the query statement 200 requested that some data in data store 125 be deleted, the query response 240 may convey whether the delete operation was successful or unsuccessful (e.g., the data could not be found).

### Processes

Following are various processes executed by the system according to various embodiments. The steps of the process are described as being performed by a system and may be performed by one or more components of the system environment shown in FIG. 1, for example, the integrated development environment 140 or the components of the server computer 110 such as the prompt rewrite module 145. Embodiments may include different and/or additional steps or perform the steps in different orders.

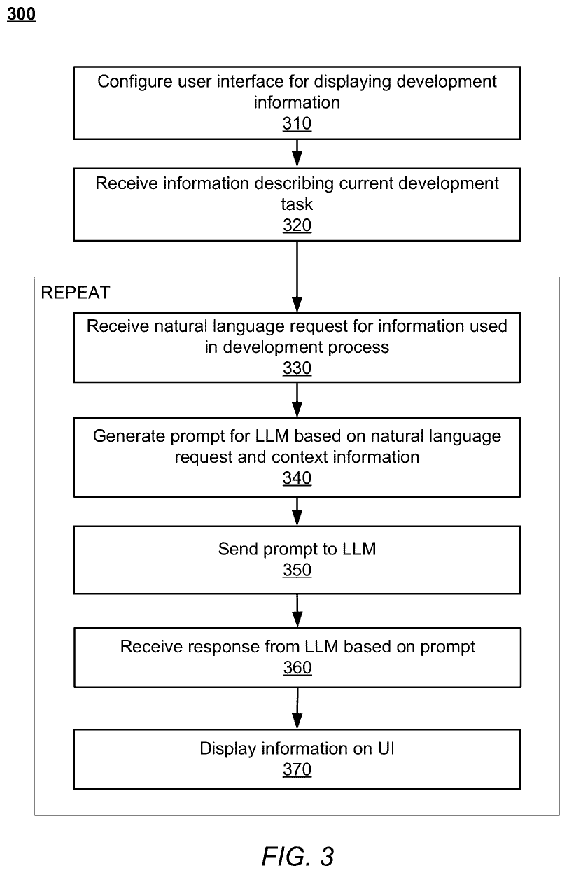

FIG. 3 is a flow chart showing a process illustrating a workflow using the integrated development environment, according to an embodiment.

The system configures 310 one or more user interfaces for displaying development information, for example, code being developed by a developer, schema of databases accessed by the code, data processed by the code including data input to the code and data generated by the code, and so on.

The system receives 320 information describing the current development task of the developer. For example, if the developer is working on a specific feature, the system receives information describing the feature. The specific feature may be a part of an application being developed by multiple developers. The system may present a user interface to the developer asking the developer to provide information describing the current development task. The system may receive a natural language description of the current development task from the user. In other embodiments, the system extracts the description of the current development task from the pull requests received from the developer while submitting code or code changes via a code repository such as GITHUB.

The system repeats the following steps 330, 340, 350, 360, 370 during the development process. The system receives 330, a natural language request for information used in the development process. The information requested may be sample code for help with the development process, database queries for interacting with a database, unit tests for testing certain feature, and so on. The system generates 340 a prompt for the large language model 150 based on the natural language request and additional context. Accordingly, the system rewrites the prompt by adding contextual information such as one or more software components relevant to the current development task, information describing the schema of the database, and so on. The system sends 350 the generated prompt to the large language model 150 for execution. The system receives 360 the response generated by the large language model 150. The system displays 370 the response generated by the large language model 150 via a user interface, for example, the user interface of the integrated development environment.

The system extracts various types of contextual information for including in the prompt. According to an embodiment, the system includes a description of the current development task of the application being developed as contextual information. The description of the current development task may be obtained from a code repository storing the code being developed, for example, within a project defined in the code repository. The system extracts the description of the project used for storing the code being developed and includes the description as part of the description of the current development task included in the contextual information.

According to an embodiment, the system extracts the comments included with recent code submissions performed by the user using the integrated development environment 140 for the application being developed. For example, the system may extract the description of a predetermined number of recent code submissions, or all code submissions submitted by the user within a threshold time interval. The descriptions of the code submissions are included as contextual information. According to an embodiment, the system extracts recent submissions by one or more other users that were submitted to the code repository within a recent time interval as contextual information indicating the active parts of code development, so that the large language model 150 generates information relevant to the portions of the application that are being actively modified. According to an embodiment, the system identifies the files or portions of code that were opened by the user using the integrated development environment 140 as an indication of portions relevant to the current development tasks and provides information describing those portions as contextual information.

The contextual information helps the large language model 150 generate information for use in the development of the application such as sample data, database queries, and sample code that is relevant to the current development task of the user. The contextual information helps focus the information generated by the large language model 150 to the current development task for a complex application being developed by multiple developers. Without the relevant development context, a large language model 150 is likely to generate information that may be relevant to the application but not particularly relevant to the current development task of the user.

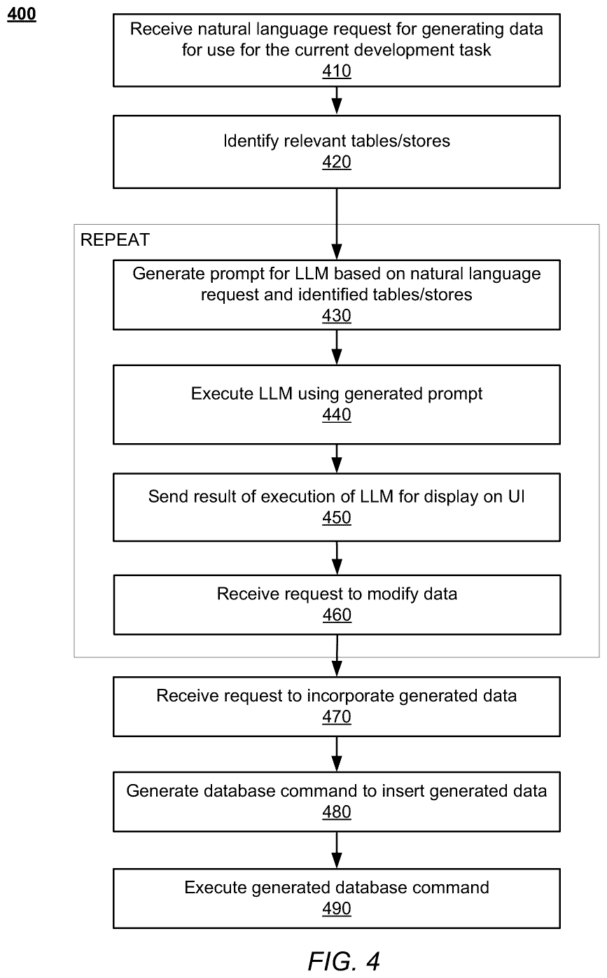

FIG. 4 is a flow chart illustrating the process of generating using the LLM, sample data for testing an application being developed, according to an embodiment.

The system receives a natural language request for generating sample data, for example, the user may input “generate sample data”. The system identifies 420 relevant tables or collections or other stores where data is stored, depending on the type of database. The system may determine stores that are relevant to the current development task. For example, the user may have created certain collections for the current development tasks and the system identifies these collections as being relevant to the current development task.

The system repeats the steps 430, 440, 450, 460 to refine the data generated. The system generates 430 a prompt for the LLM by initializing the prompt to the natural language request received and rewriting the prompt to add additional contextual information including a description of the current development task and the description of the schema including the tables/collections and other stores relevant to the current development task. The system executes 440 the LLM using the generated prompt. The system sends 450 the result of execution of the LLM for display on a UI of the integrated development environment 140. The user may inspect the generated data and send a request to modify the data. Accordingly, the user may request certain attributes to conform to certain constraints, for example, use values of date of birth attribute to be in a particular range, to use realistic names, or to use address attributes from a particular location. The system repeats the steps 430, 440, 450, for the new request from the user and this process may be repeated until the data generated conforms to the user requirements.

The system may further receive a request 470 to incorporate the generated data in the data stores used by the application. Accordingly, the system may request the large language model 150 to generate a schema for the database for storing the sample data generated. The system may use the large language model 150 to generate a database command to create the schema using the database. The system may use the large language model 150 to generate a database command to insert the generated data 480 in one or more tables or collections. The system may use the large language model 150 to generate database queries to access the generated data 480 from one or more tables or collections. The system may use the large language model 150 to describe possible indexes of the database tables that would improve the execution of the database queries generated. The system may use the large language model 150 to generate database commands for generating the indexes of the database tables that would improve the execution of the database queries generated. The system may use the large language model 150 to generate sample code in the programming language of the application to run the database commands and database queries generated. The system executes 490 the generated database commands or queries, for example, in response to a request received from the user, or as part of execution of the code of the application being developed.

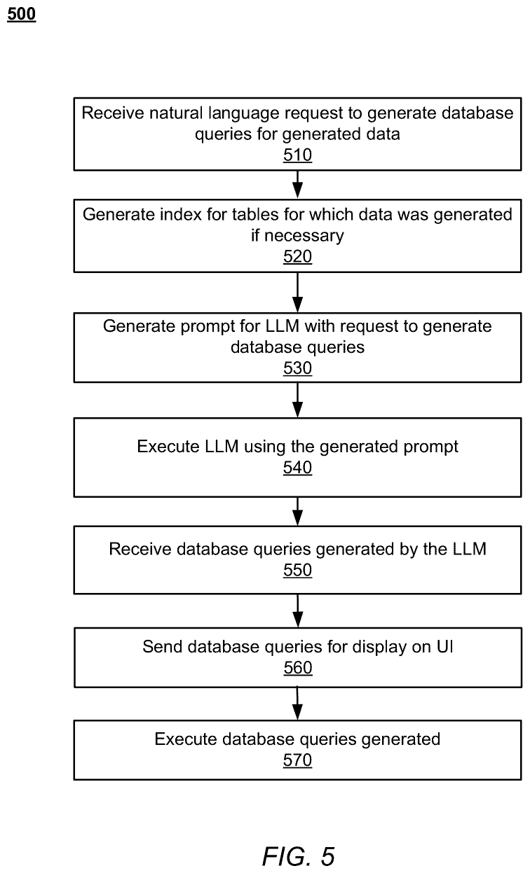

FIG. 5 is a flow chart illustrating the process of generating database queries based on LLMs, according to an embodiment. The system receives 510 a natural language request to generated database queries, for example, for the data generated by the process illustrated in FIG. 4.

The system generates 530 a prompt for LLM by rewriting the natural language request from the user requesting the LLM to generate database queries. The prompt may include contextual information, for example, information describing the sample data that the database queries need to access. The database queries may process data stored in other tables/collections in addition to the table/collection storing the data generated by the process illustrated in FIG. 4. The system executes 540 the LLM using the generated prompt. The system receives 550 the database queries generated by the LLM and sends 560 the generated database queries for display via a user interface, for example, the UI of the integrated development environment 140. The integrated development environment 140 may send the generated database queries for execution, for example, in response to a user request.

The system may generate 520 one or more indexes for the tables or collections for which the data was generated. According to an embodiment, the system generates a prompt requesting the LLM to determine the indexes needed for efficiently executing the database queries. The system may generate a prompt that requests the LLM to generate the database commands for generating the indexes for efficiently executing the database query. The system provides the prompt to the LLM to execute the LLM and receive the requested index information or the database commands for generating the indexes. The system executes the generated database commands to generate the required indexes and then executed the database queries.

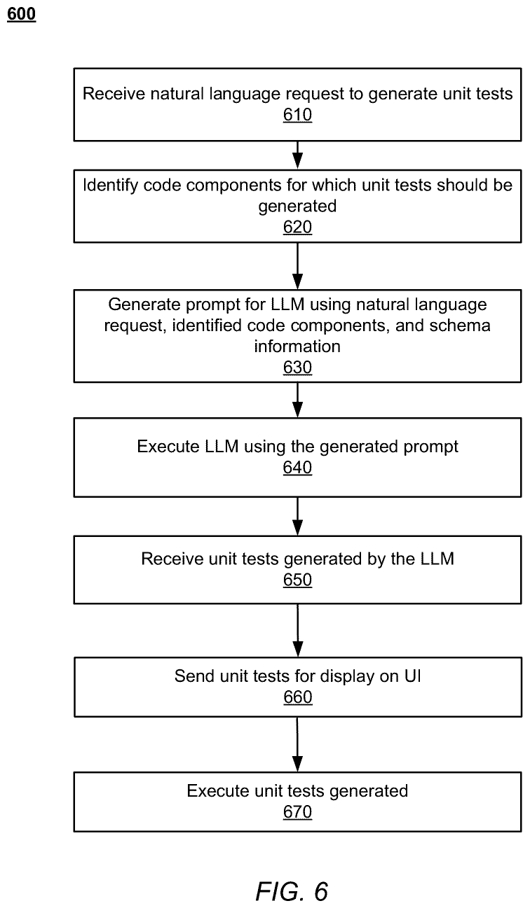

FIG. 6 is a flow chart illustrating the process of generating unit tests using LLMs, according to an embodiment. The system receives 610 a natural language request to generate unit tests for the current development task for a subset of the current development task. The system identifies 620 the code components for which the unit tests need to be generated. These code components may be the code components added by the developer for the current development task or code components modified by the developer in connection with the current development task. The system generates 630 a prompt for the LLM based on the natural language request from the user enhanced with information describing the identified code components and schema information. The system executes 640 the LLM using the generated prompt. The system receives 650 the unit tests generated by the LLM and sends 660 the generated tests for display, for example, by a user interface of the integrated development environment 140. The system may execute the generated unit tests, for example, upon request by the user.

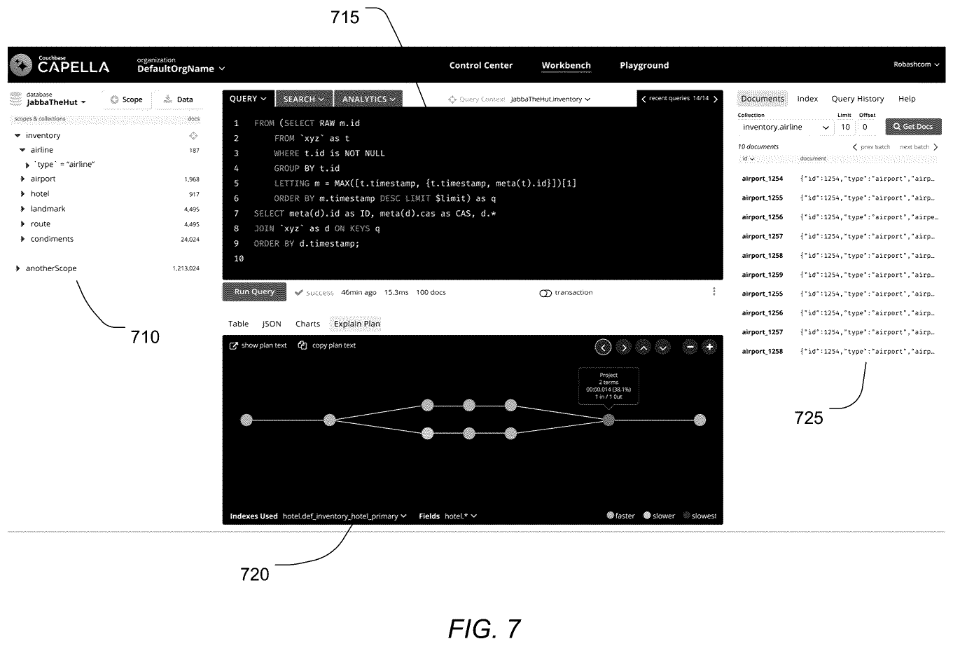

FIG. 7 shows a user interface of the integrated development environment, according to an embodiment. The example user interface shows various UI components, for example, panels that display different types of information. For example, the panel 710 displays details of the schema comprising the various collections or tables. The panel 715 shows database queries that may be executed using the schema. Panel 720 shows an example execution plan for a database query displayed in panel 715. The execution plan may identify certain performance issues for example by identifying a node of the execution plan that is acting as a performance bottleneck. The panel 725 shows example data, for example, certain objects or documents from a collection processed by the database query shown in the panel 715 or an output of the database query shown in the panel 715.

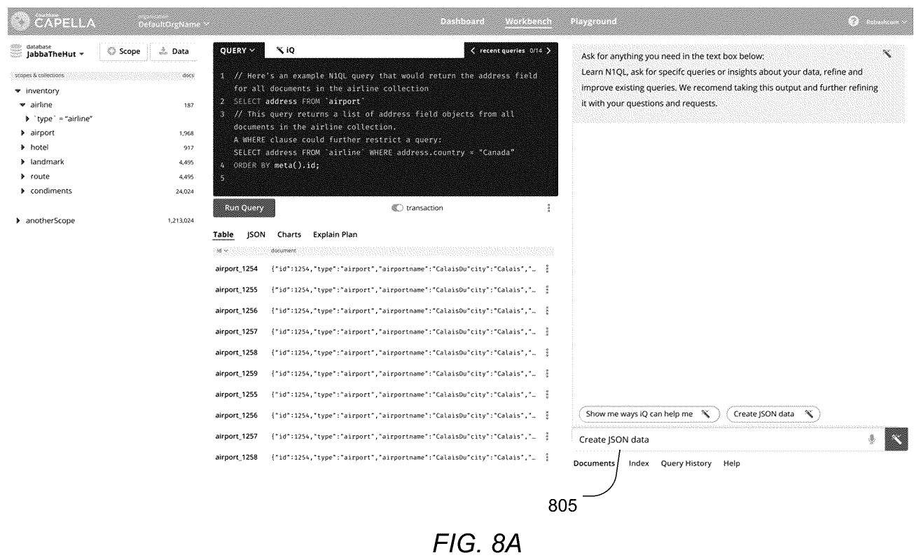

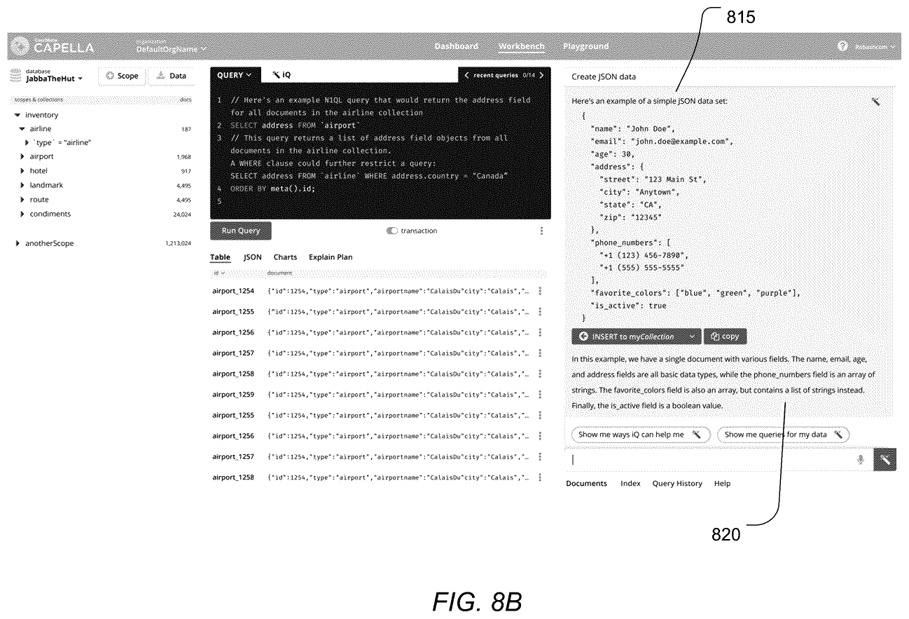

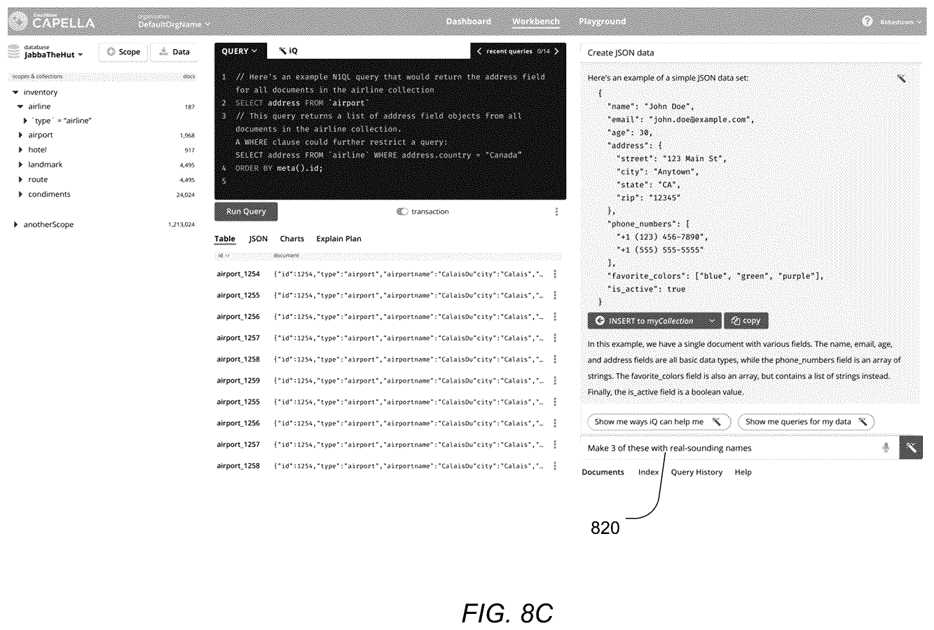

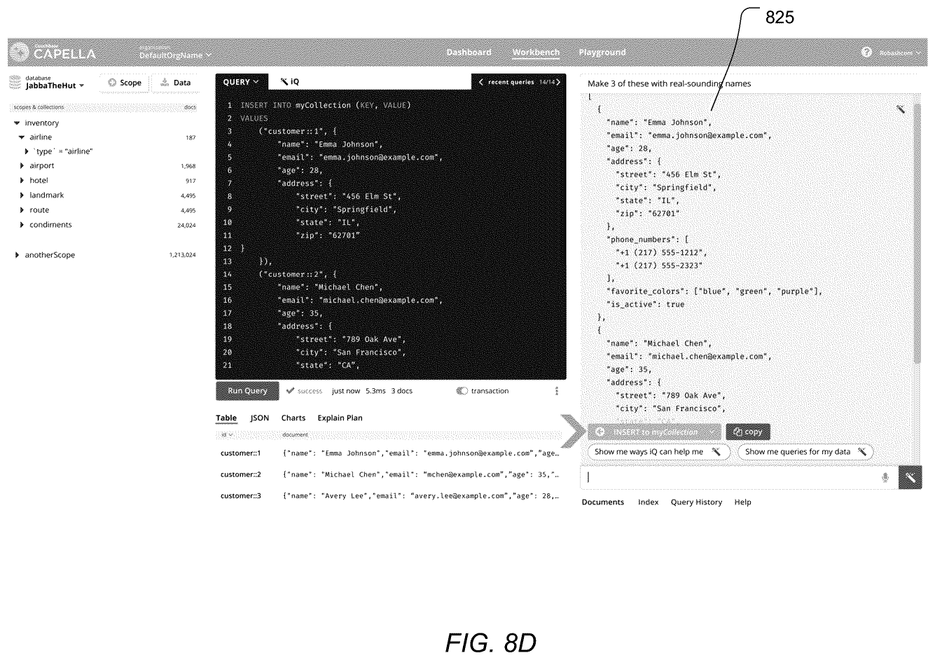

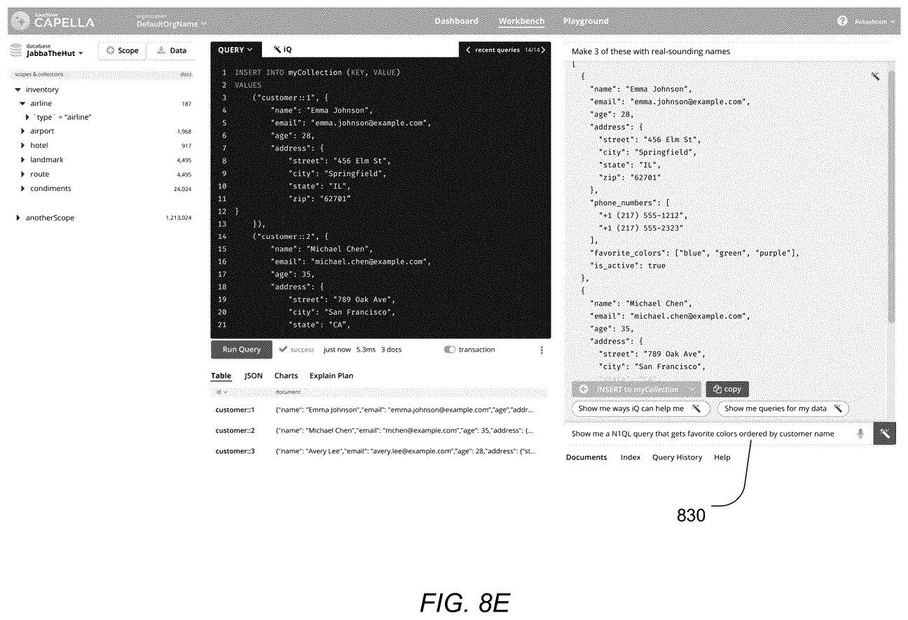

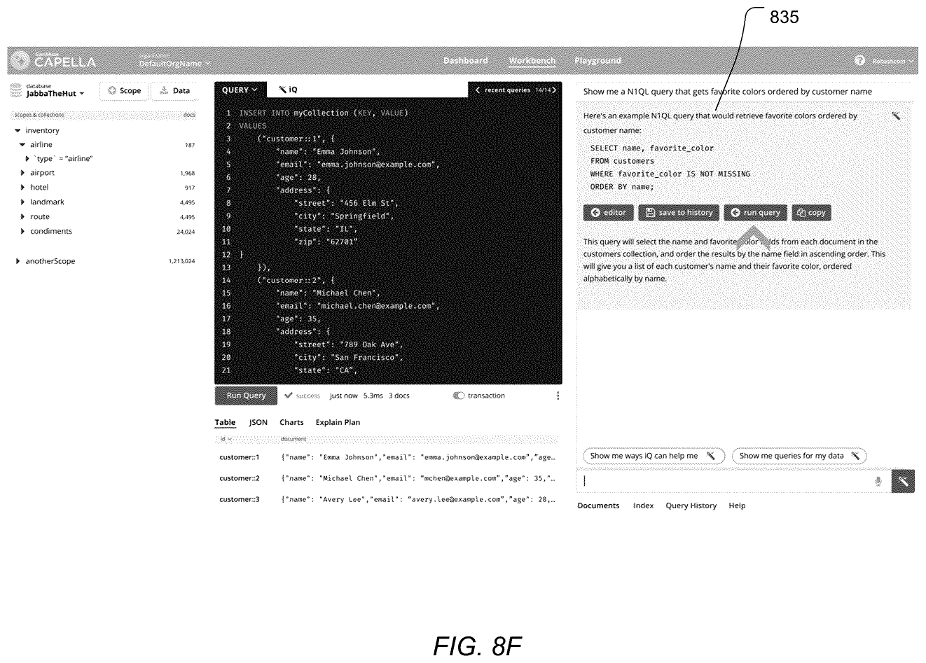

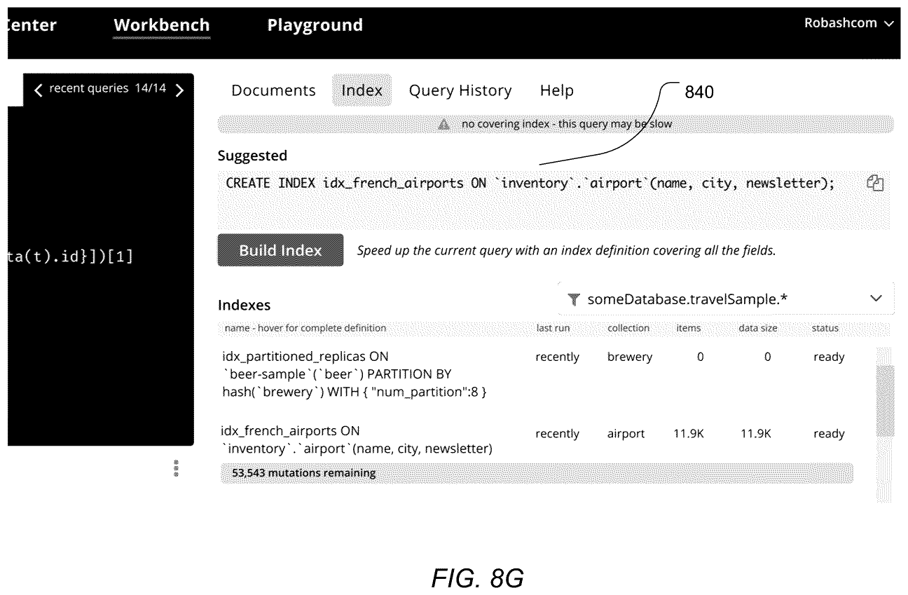

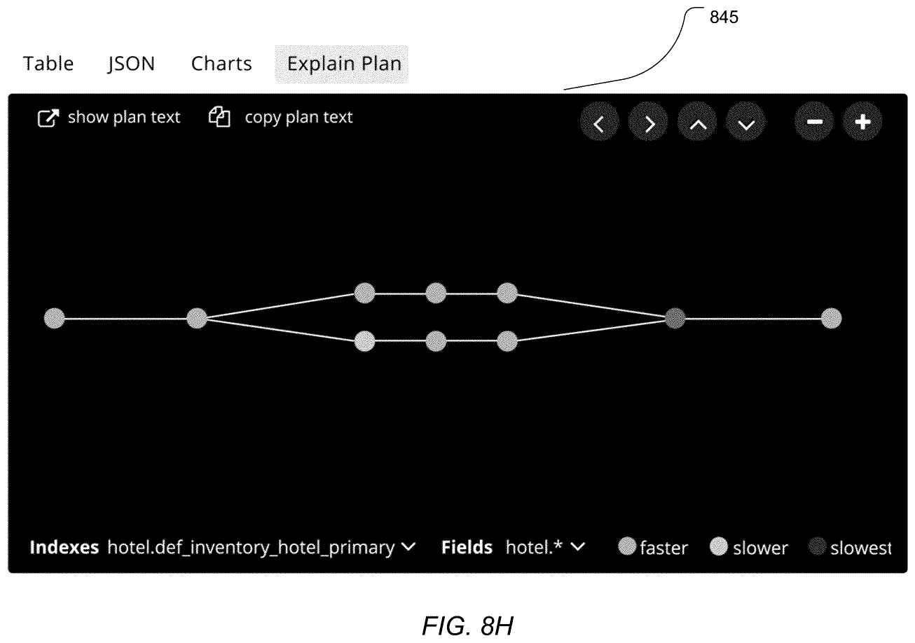

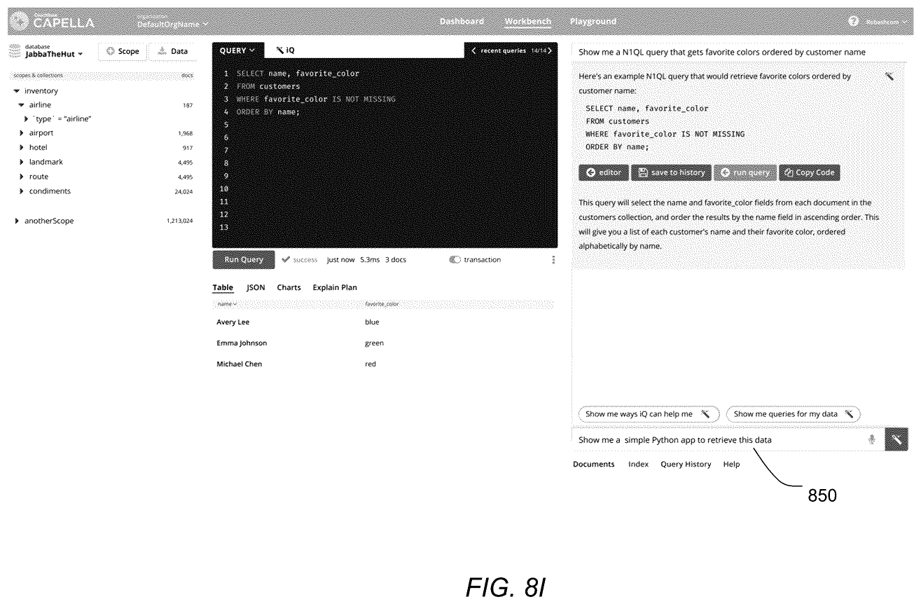

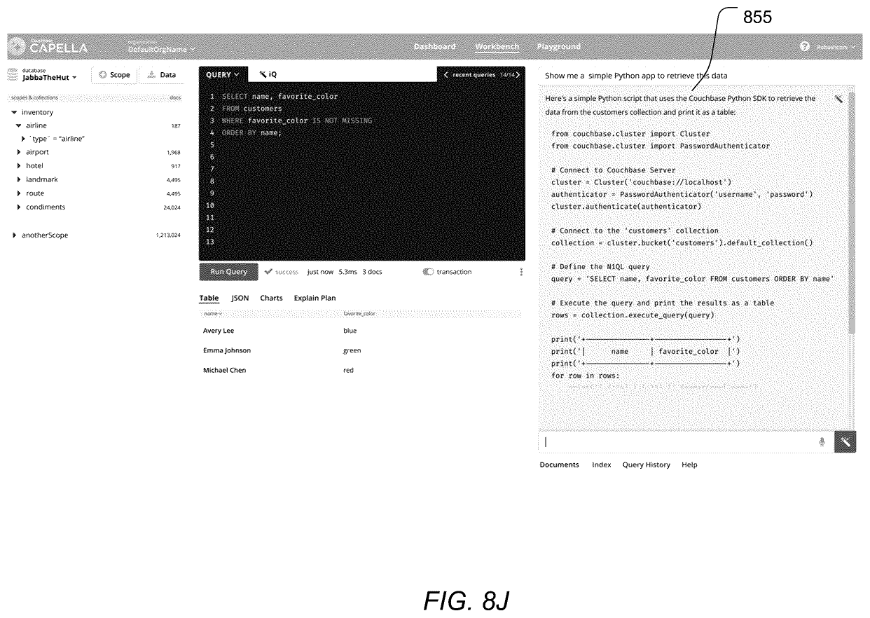

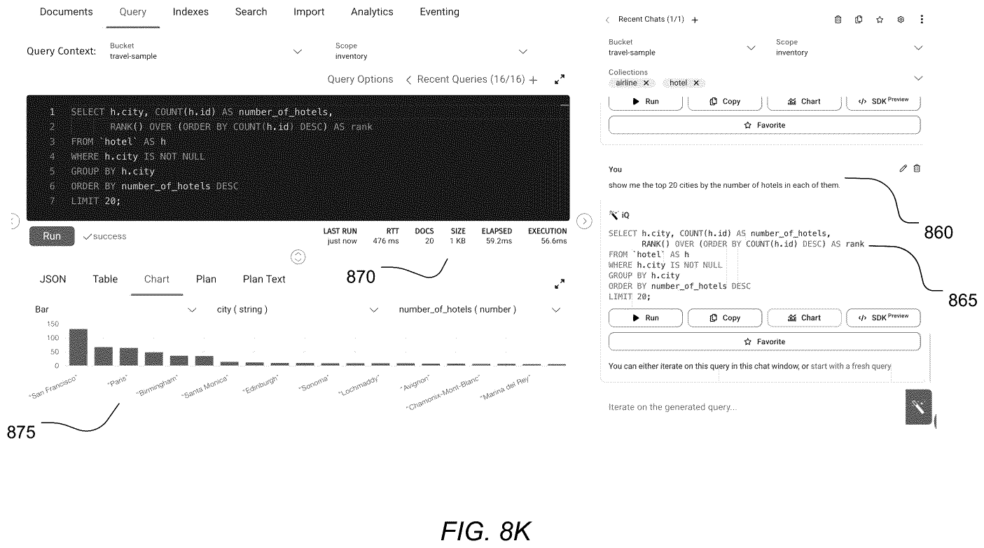

FIG. 8A shows an example user interface of the integrated development environment receiving a user request to generate data, according to an embodiment. A widget for receiving text input receives a natural language text from user requesting the system to generate data, for example, “create JSON data.” The natural language request may specify the format in which the user wants to generate the data, for example, JSON format.

FIG. 8B shows an example user interface of the integrated development environment displaying the generates data, according to an embodiment. A panel of the UI of the integrated development environment 140 shows the generated data 815. The panel may also provide an explanation 820 describing the generated data.

FIG. 8C shows an example user interface of the integrated development environment receiving a user request to modify the generated data, according to an embodiment. For example, the user requests the system to modify three of the objects to use real-sounding names.

FIG. 8D shows an example user interface of the integrated development environment displaying the generates data, according to an embodiment. The system regenerates the data as requested by the user and displays the regenerated data 825.

FIG. 8E shows an example user interface of the integrated development environment receiving a user request to generate a query to access the generated data, according to an embodiment. For example, the user provides 830 a request to the system to generate a database query and may specify information such as the ordering of the results.

FIG. 8F shows an example user interface of the integrated development environment displaying the generated data, according to an embodiment. The system generated the query 835 as requested by the user.

FIG. 8G shows an example user interface of the integrated development environment displaying an index generated by the system, according to an embodiment. For example, the system may generate an index 840 to efficiently executing queries for accessing the generated data.

FIG. 8H shows an example user interface of the integrated development environment displaying an execution plan 845, according to an embodiment.

FIG. 8I shows an example user interface of the integrated development environment receiving a user request to generate code to access the generated data, according to an embodiment. For example, the user provides 850 a request to the system to generate a python application to access the data.

FIG. 8J shows an example user interface of the integrated development environment displaying the code 855 for accessing the generated data, according to an embodiment.

FIG. 8K shows an example user interface of the integrated development environment displaying information generated, according to an embodiment.

The system may perform various actions in response to a natural language request 860 (or query) received from a user via the user interface of the integrated development environment. The system may generate a database query 865, for example, a query specified using a database query language such as SQL (structured query language) or SQL++. The system may generate the database query and automatically execute the database query to generate a resultset 870 and returns the resultset, for example, for display via the user interface of the integrated development environment. The system may further, automatically determine a type of chart that represents the resultset data for understanding the data and analysis of the data. The system may automatically generate one or more charts 875 for visually displaying the resultset.

### Computer Architecture

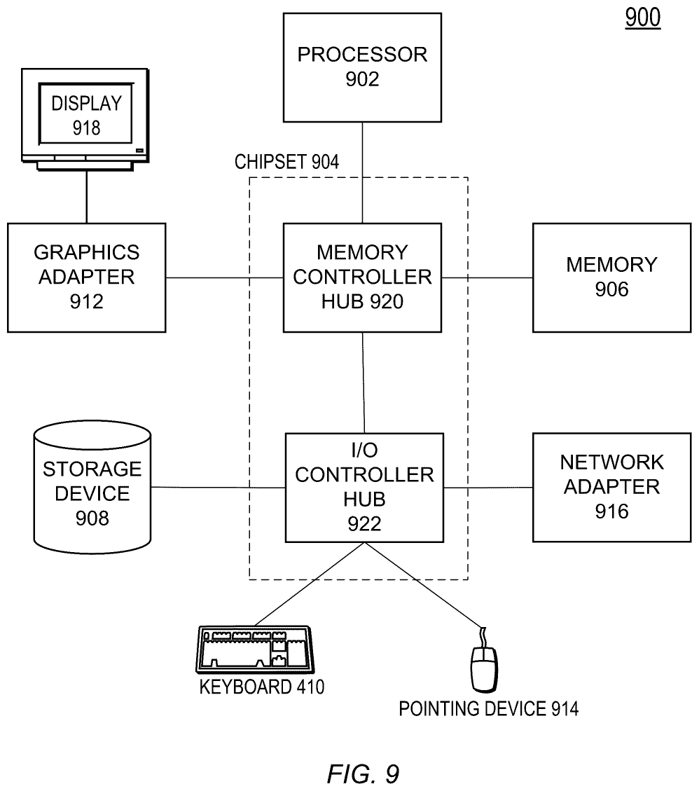

FIG. 9 is a high-level block diagram illustrating a functional view of a typical computer (or computer system) for use as one of the entities illustrated in the environment 100 of FIG. 1 according to an embodiment. Illustrated are at least one processor 902 coupled to a chipset 904. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O controller hub 922. In another embodiment, the memory 906 is coupled directly to the processor 902 instead of the chipset 904.

The storage device 908 is a non-transitory computer-readable storage medium, such as a hard drive, compact disk read-only memory (CD-ROM), DVD, or a solid-state memory device. The memory 906 holds instructions and data used by the processor 902. The pointing device 914 may be a mouse, track ball, or other type of pointing device, and is used in combination with the keyboard 910 to input data into the computer 900. The graphics adapter 912 displays images and other information on the display 918. The network adapter 916 couples the computer 900 to a network.

As is known in the art, a computer 900 can have different and/or other components than those shown in FIG. 4. In addition, the computer 900 can lack certain illustrated components. For example, a computer 900 acting as server computer 110 may lack a keyboard 910 and a pointing device 914. Moreover, the storage device 908 can be local and/or remote from the computer 900 (such as embodied within a storage area network (SAN)).

The computer 900 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 908, loaded into the memory 906, and executed by the processor 902.

The types of computers used by the entities of FIG. 1 can vary depending upon the embodiment and the processing power used by the entity. For example, a client device 115 may be a mobile phone with limited processing power, a small display 918, and may lack a pointing device 914. The server computer 110, in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps of computer-implemented methods and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

What is claimed is:

1. A computer-implemented method comprising:
configuring a user interface of an integrated development environment for developing database applications, wherein the user interface is configured to display one or more of: code being developed for a database application, a schema of a database for storing data of the database application, or sample data processed by the database application;
sending the user interface of the integrated development environment for display via a client device;
receiving via the user interface of the integrated development environment, a natural language request for information related to development of the database application;
determining contextual information describing a development task associated with the database application being developed;
generating a prompt for input to a machine learning based language model based on the natural language request and the contextual information;
providing the prompt to the machine learning based language model for execution;
receiving a response to the prompt from the machine learning based language model;
extracting the information related to development of the database application from the response generated by the machine learning based language model; and
displaying the information via the user interface of the integrated development environment.

2. The computer-implemented method of claim 1, wherein the information related to development of the database application represents sample data for providing as input to the code being developed for the database application.

3. The computer-implemented method of claim 1, wherein the contextual information describing the development task associated with the database application being developed comprises description of one or more code submissions to a code repository storing code of the database application being developed.

4. The computer-implemented method of claim 1, wherein the integrated development environment stores code of the database application being developed in a code repository, the computer-implemented method further comprising:
accessing from a code repository, information describing a project associated with the database application being developed, wherein the contextual information comprises the information describing the project.

5. The computer-implemented method of claim 1, wherein the information related to development of the database application represents description of a schema for storing data processed by the database application.

6. The computer-implemented method of claim 5, wherein the information related to development of the database application represents database commands for generating the schema of a database for storing data processed by the database application.

7. The computer-implemented method of claim 5, wherein the information related to development of the database application represents one or more of:
a database query for accessing data stored using the schema of the database;
a resultset obtained by executing the database query; or
a chart representing the resultset obtained by executing the database query.

8. The computer-implemented method of claim 7, wherein the information related to development of the database application represents information describing one or more indexes for efficient execution of the one or more database queries for accessing data stored using the schema of the database.

9. The computer-implemented method of claim 7, wherein the information related to development of the database application represents database commands for generating one or more indexes for efficient execution of the one or more database queries for accessing data stored using the schema of the database, the computer-implemented method further comprising:
executing the database commands for generating the one or more indexes for efficient execution of the one or more database queries.

10. The computer-implemented method of claim 7, wherein the information related to development of the database application represents one or more unit tests for testing the database application.

11. A non-transitory computer readable storage medium storing instructions that when executed by one or more computer processors, cause the one or more computer processors to performs steps comprising:
configuring a user interface of an integrated development environment for developing database applications, wherein the user interface is configured to display one or more of: code being developed for a database application, a schema of a database for storing data of the database application, or sample data processed by the database application;
sending the user interface of the integrated development environment for display via a client device;
receiving via the user interface of the integrated development environment, a natural language request for information related to development of the database application;
determining contextual information describing a development task associated with the database application being developed;
generating a prompt for input to a machine learning based language model based on the natural language request and the contextual information;
providing the prompt to the machine learning based language model for execution;
receiving a response to the prompt from the machine learning based language model;
extracting the information related to development of the database application from the response generated by the machine learning based language model; and
displaying the information via the user interface of the integrated development environment.

12. The non-transitory computer readable storage medium of claim 11, wherein the information related to development of the database application represents sample data for providing as input to the code being developed for the database application.

13. The non-transitory computer readable storage medium of claim 11, wherein the contextual information describing the development task associated with the database application being developed comprises description of one or more code submissions to a code repository storing code of the database application being developed.

14. The non-transitory computer readable storage medium of claim 11, wherein the integrated development environment stores code of the database application being developed in a code repository, the instructions causing the one or more computer processors to performs steps comprising:
accessing from a code repository, information describing a project associated with the database application being developed, wherein the contextual information comprises the information describing the project.

15. The non-transitory computer readable storage medium of claim 11, wherein the information related to development of the database application represents description of a schema for storing data processed by the database application.

16. The non-transitory computer readable storage medium of claim 15, wherein the information related to development of the database application represents database commands for generating the schema of a database for storing data processed by the database application.

17. The non-transitory computer readable storage medium of claim 15, wherein the information related to development of the database application represents one or more of:
a database query for accessing data stored using the schema of the database;
a resultset obtained by executing the database query; or
a chart representing the resultset obtained by executing the database query.

18. The non-transitory computer readable storage medium of claim 17, wherein the information related to development of the database application represents information describing one or more indexes for efficient execution of the one or more database queries for accessing data stored using the schema of the database.

19. The non-transitory computer readable storage medium of claim 17, wherein the information related to development of the database application represents database commands for generating one or more indexes for efficient execution of the one or more database queries for accessing data stored using the schema of the database, the instructions causing the one or more computer processors to performs steps comprising:
executing the database commands for generating the one or more indexes for efficient execution of the one or more database queries.

20. A computer system comprising:
one or more computer processors; and
a non-transitory computer readable storage medium storing instructions that when executed by one or more computer processors, cause the one or more computer processors to performs steps comprising:
configuring a user interface of an integrated development environment for developing database applications, wherein the user interface is configured to display one or more of: code being developed for a database application, a schema of a database for storing data of the database application, or sample data processed by the database application;
sending the user interface of the integrated development environment for display via a client device;
receiving via the user interface of the integrated development environment, a natural language request for information related to development of the database application;
determining contextual information describing a development task associated with the database application being developed;
generating a prompt for input to a machine learning based language model based on the natural language request and the contextual information;
providing the prompt to the machine learning based language model for execution;
receiving a response to the prompt from the machine learning based language model;
extracting the information related to development of the database application from the response generated by the machine learning based language model; and
displaying the information via the user interface of the integrated development environment.
